(19) United States
(12) Patent Application Publication
(10) Pub. No.: US 2017/0066425 A1
(43) Pub. Date: Mar. 9, 2017

(54) DEVICE FOR CONTROLLING PARKING AND METHOD FOR CONTROLLING PARKING

(71) Applicant: Hyundai Motor Company, Seoul (KR)

(72) Inventor: Yong Pil Kim, Incheon, (KR)

(21) Appl. No.: 14/941,707

(22) Filed: Nov. 16, 2015

(30) Foreign Application Priority Data
Sep. 8, 2015 (KR) 10-2015-0127104

(51) Int. Cl. B60T 17/22; B60Q 9/00

(52) U.S. Cl. CPC B60T 17/22; B60Q 9/002; B60T 2210/12; B60T 2230/02

(57) ABSTRACT

A method and system are provided for controlling parking. The method includes measuring a road surface friction coefficient or an inclination angle of a road surface and detecting a parking braking force by a parking motor of a parking system. A minimum parking braking force necessary for the parking is calculated using at least one of the road surface friction coefficient, the inclination angle, and a vehicle weight. The parking braking force and the minimum parking braking force are then compared to determine whether the parking is possible.

### CROSS-REFERENCE TO RELATED APPLICATION

This application claims priority to and the benefit of Korean Patent Application No. 10-2015-0127104 filed in the Korean Intellectual Property Office on Sep. 8, 2015, the entire contents of which are incorporated herein by reference.

### BACKGROUND

(a) Field of the Invention

The present invention relates to a device and method for controlling parking on an inclined road, and more particularly, to a device and method for controlling parking on an inclined road and providing a warning to a driver.

(b) Description of the Related Art

Generally, a parking brake system is a brake system operated when a vehicle is parked. Recently, a parking method is changing from a mechanical method to an electric method. However, a method for determining whether parking is possible on an inclined road depends on driver experience. Accordingly, accidents due to a rolling or sliding of the vehicle on the inclined road may occur. Thus, there is a need for technology for warning the driver when the parking is impossible on the inclined road.

The above information disclosed in this section is merely for enhancement of understanding of the background of the invention and therefore it may contain information that does not form the prior art that is already known in this country to a person of ordinary skill in the art.

### SUMMARY

The present invention provides for controlling parking on an inclined road having advantages of determining an impossible parking condition on the inclined road and outputting a warning to a driver accordingly.

An exemplary embodiment of the present invention provides a method for controlling parking that may include: measuring a road surface friction coefficient or an inclination angle of a road surface; detecting a parking braking force by a parking motor of a parking system; calculating a minimum parking braking force necessary for the parking using at least one of the road surface friction coefficient, the inclination angle, or a vehicle weight; and comparing the parking braking force and the minimum parking braking force and determining whether the parking is possible.

The determination of whether the parking is possible may include determining that the parking is impossible when the parking braking force is less than the minimum parking braking force. The method may further include calculating a limited parking braking force using at least one of a position of the parking system, a slope condition of an uphill or downhill road, and the inclination angle. The determination of whether the parking is possible may include comparing the minimum parking braking force and the limited parking braking force, and determining that the parking is impossible when the limited parking braking force is less than the minimum parking braking force.

The method may further include calculating a vehicle limited inclination angle when the parking braking force is greater than the minimum parking braking force and the limited parking braking force is greater than the minimum parking braking force. The determination of whether the parking is possible may further include determining that the parking is impossible when the measured inclination angle is greater than the vehicle limited inclination angle. In addition, the determination of whether the parking is possible may include operating a parking warning system by a parking warning signal when the parking is impossible to thus output a warning to a driver.

An exemplary embodiment of the present invention provides a device for controlling parking that may include: a measuring unit configured to measure a road surface friction coefficient or an inclination angle of a road surface; a calculation unit configured to calculate a minimum parking braking force necessary for a parking using at least one of the road surface friction coefficient, the inclination angle, or a vehicle weight, or calculate a limited parking braking force; and a controller configured to compare at least one of a parking braking force generated by a parking motor, the minimum parking braking force, and the limited parking braking force, and determine whether the parking is possible.

The calculation unit may include a minimum parking braking force calculation unit configured to calculate the minimum parking braking force necessary for the parking using at least one of the road surface friction coefficient, the inclination angle, and the vehicle weight, and a limited parking braking force calculation unit configured to calculate a limited parking braking force using at least one of a position of the parking system, a slope condition of an uphill or downhill road, and the inclination angle. The controller may further be configured to determine that the parking is impossible when the parking braking force is less than the minimum parking braking force.

Additionally, the controller may be configured to determine that the parking is impossible when the limited parking braking force is less than the minimum parking braking force. The calculation unit may include a limited inclination angle calculation unit configured to calculate a vehicle limited inclination angle when the parking braking force is greater than the minimum parking braking force and the limited parking braking force is greater than the minimum parking braking force. The controller may be configured to determine that the parking is impossible when the measured inclination angle is greater than the vehicle limited inclination angle. The controller may be configured to generate a parking warning signal when the parking is impossible.

According to the present invention for achieving the object, by determining whether the parking is possible using the parking braking force by a parking motor, the minimum parking braking force, the limited parking braking force, and the limited inclination angle, it may be possible to output a warning to the driver whether the parking is possible on the inclined road, to thus more stably park the vehicle on the inclined road.

### BRIEF DESCRIPTION OF THE DRAWINGS

The above and other features of the present invention will now be described in detail with reference to exemplary embodiments thereof illustrated the accompanying drawings which are given herein below by way of illustration only, and thus are not limitative of the present invention, and wherein:

FIG. 1 is a diagram of a device for controlling parking according to an exemplary embodiment of the present invention;

FIG. 2 is a flowchart showing a process for determining a parking condition and warning a driver according to an exemplary embodiment of the present invention;

FIG. 3 is a diagram showing rear wheel parking on a downhill road according to an exemplary embodiment of the present invention; and

FIG. 4 is a diagram showing rear wheel parking on an uphill road according to an exemplary embodiment of the present invention.

### DETAILED DESCRIPTION

In the following detailed description, exemplary embodiments of the present invention have been shown and described, simply by way of illustration. As those skilled in the art would realize, the described exemplary embodiments may be modified in various different ways, all without departing from the spirit or scope of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g., fuel derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

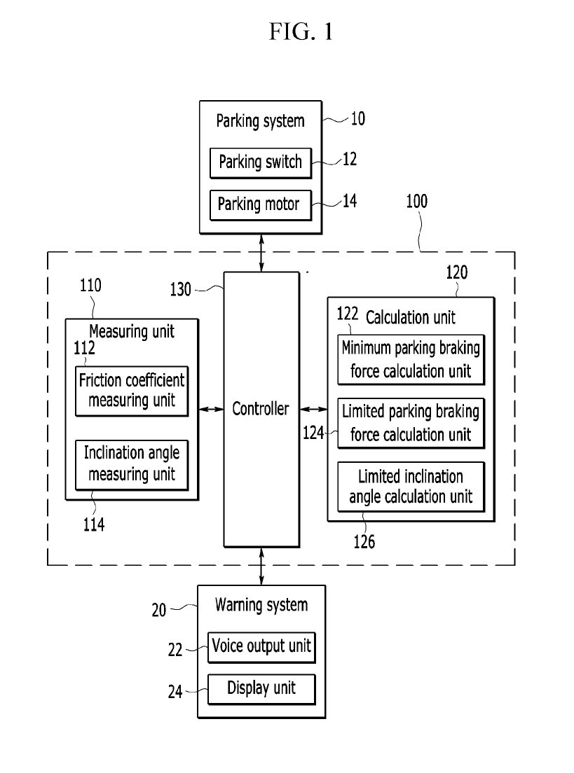

A device and method for controlling parking on a slope will now be described with reference to FIG. 1 to FIG. 4. In particular, FIG. 1 is a diagram of a device for controlling parking according to an exemplary embodiment of the present invention. For convenience of explanation, a configuration of the device for controlling parking according to the exemplary embodiment of the present invention is schematically illustrated, but the device for controlling parking is not limited thereto.

The device for controlling parking 100 according to an exemplary embodiment of the present invention may be configured to detect a parking braking force by a parking motor 14 of a parking system 10, compare a parking braking force, a minimum parking braking force, and a limited parking braking force necessary for parking, and output a warning to a driver through a voice output unit 22 and a display unit 24 of a warning system 20 when the parking is impossible. Referring to FIG. 1, the device for controlling parking 100 according to an exemplary embodiment of the present invention may include a measuring unit 110 (e.g., a sensor), a calculation unit 120, and a controller 130. The controller 130 may be configured to operate the measuring unit 110 and the calculation unit 120.

The measuring unit 110 may be configured to measure a road surface friction coefficient or an inclination angle of a road surface when a parking switch 12 is operated, and provide the measured road surface friction coefficient and the measured inclination angle to the controller 130. The measuring unit 110 may include a friction coefficient measuring unit 112 and an inclination angle measuring unit 114 according to an exemplary embodiment of the present invention. The friction coefficient measuring unit 112 may be configured to measure the road surface friction coefficient of the road surface. The inclination angle measuring unit 114 may also be configured to measure the inclination angle of the road surface.

The calculation unit 120 may be configured to calculate a minimum parking braking force and a limited parking braking force using of the road surface friction coefficient, the inclination angle, and a slope condition of the road surface. The minimum parking braking force may include a minimum value of a parking braking force necessary for parking on an inclined road. Additionally, the limited parking braking force may include a limited value of the parking braking force by the parking motor based on a vehicle condition and an inclination angle of the road surface. The calculation unit 120 may include a minimum parking braking force calculation unit 122, a limited parking braking force calculation unit 124, and a limited inclination angle calculation unit 126 according to an exemplary embodiment of the present invention.

The minimum parking braking force calculation unit 122 may be configured to calculate the minimum parking braking force using the road surface friction coefficient, the inclination angle, and a vehicle weight. The limited parking braking force calculation unit 124 may be configured to calculate the limited parking braking force using a position of the parking system, a slope condition of an uphill or downhill road, and the inclination angle of the road surface. The limited inclination angle calculation unit 126 may be configured to calculate a vehicle limited inclination angle that satisfies that the parking braking force of the parking system 10 is greater than the minimum parking braking force and the limited parking braking force is greater than the minimum parking braking force.

Further, the controller 130 may be configured to determine whether the parking is possible by comparing the parking braking force by a parking motor, the minimum parking braking force, and the limited parking braking force. For example, the controller 130 may be configured to determine that the parking is impossible due to a wheel rolling when the parking braking force is less than the minimum parking braking force. The controller 130 may also be configured to determine that the parking is impossible due to sliding of the vehicle when the limited parking braking force is less than the minimum parking braking force. The controller 130 may be configured to determine that the parking is impossible when the inclination angle measured by the measuring unit 110 is greater than the vehicle limited inclination angle calculated by the calculation unit 120.

Accordingly, the controller 130 may be implemented with at least one processor operating by a predetermined program, and the predetermined program may be programmed to perform each step according to a method for controlling parking according to an exemplary embodiment of the present invention.

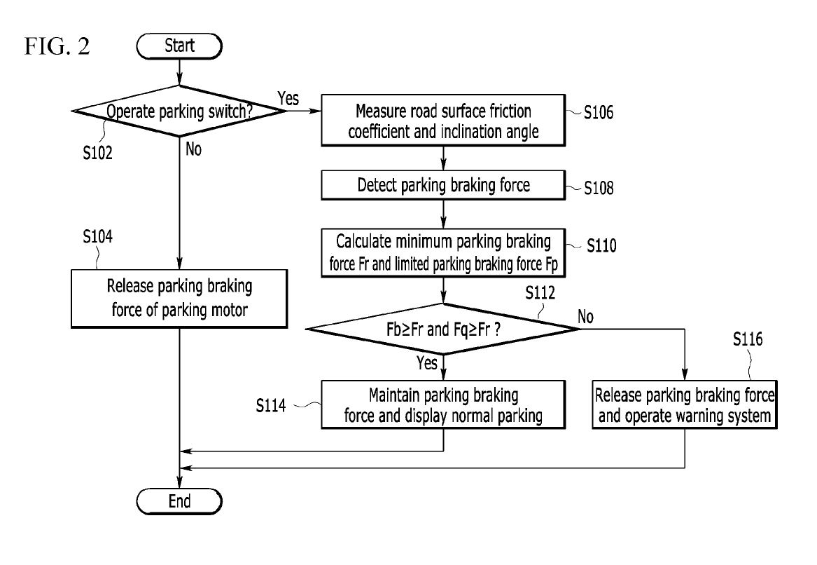

FIG. 2 is a flowchart briefly showing a process for determining a parking condition and warning a driver according to an exemplary embodiment of the present invention. The following flowchart will be described with the same reference numerals as those of a configuration of FIG. 1. Referring to FIG. 2, the device for controlling parking 100 according to an exemplary embodiment of the present invention may be configured to detect an operating state of the parking switch 12 of the parking system at step S102. The device described herein below may be operated by the controller.

The device for controlling parking 100 may be configured to measure the road surface friction coefficient and the inclination angle when the parking switch is operated, and detect the parking braking force Fb generated by the parking motor 14 at steps S106 and S108. The device for controlling parking 100 may further be configured to calculate the parking braking force Fb using brake elements, brake efficiency, and a tire radius. The device for controlling parking 100 may be configured to calculate the minimum parking braking force Fr, the limited parking braking force Fp, and the limited inclination angle using the road surface friction coefficient, the inclination angle, and vehicle information at step S110. The vehicle information may include a vehicle weight and a position of the parking system of a front or rear wheel. The minimum parking braking force Fr may include a force generated by a vehicle weight.

The device for controlling parking 100 may be configured to calculate the minimum parking braking force Fr using the following Equation 1.

$${F}_{r} = Mg sin θ = \frac{MgS}{\sqrt{{( 1 + S )}^{2}}} \qquad Equation 1$$

wherein, M denotes a total mass of a vehicle, g denotes gravity acceleration, and S denotes a degree of inclination of the road surface.

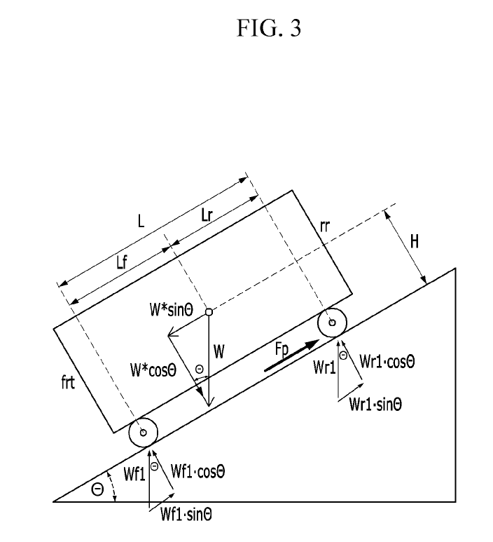

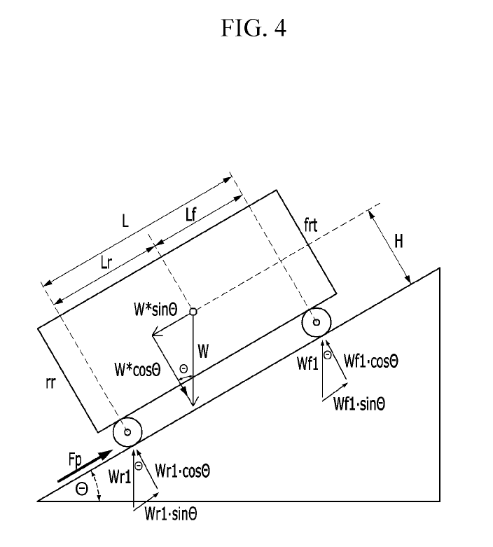

FIG. 3 is a diagram showing rear wheel parking on a downhill road according to an exemplary embodiment of the present invention, and FIG. 4 is a diagram showing rear wheel parking on an uphill road according to an exemplary embodiment of the present invention.

The limited parking braking force Fp depends on a position of the parking system (e.g., front wheel or rear wheel), a slope condition (e.g., uphill or downhill road), and the inclination angle. The device for controlling parking 100 may be configured to calculate the limited parking braking force Fp using the following Equations 2 to 5.

$$\begin{matrix}{F}_{p} = {μ}_{r} \times ( {W}_{r} cos θ - \frac{H}{L} W sin θ ) & Equation 2 \\ {F}_{p} = {μ}_{r} \times ( {W}_{r} cos θ + \frac{H}{L} W sin θ ) & Equation 3 \\ {F}_{p} = {μ}_{f} \times ( {W}_{f} cos θ + \frac{H}{L} W sin θ ) & Equation 4 \\ {F}_{p} = {μ}_{f} \times ( {W}_{f} cos θ - \frac{H}{L} W sin θ ) & Equation 5\end{matrix}$$

In particular, Equation 2 is an equation that calculates the limited parking braking force when the parking system is mounted in a rear wheel of the vehicle and the vehicle is parked on a downhill road, and Equation 3 is an equation that calculates the limited parking braking force when the parking system is mounted in the rear wheel and the vehicle is parked on a uphill road. Equation 4 is an equation that calculates the limited parking braking force when the parking system is mounted in a front wheel of the vehicle and the vehicle is parked on the downhill road, and Equation 5 is an equation that calculates the limited parking braking force when the parking system is mounted in the front wheel and the vehicle is parked on the uphill road.

Wherein, μᵣ is a friction coefficient between a road surface and a tire when the parking system is mounted in the rear wheel, μ_{f} and is the friction coefficient between the road surface and the tire when the parking system is mounted in the front wheel. In addition, Wᵣ is a weight of the rear wheel on a flat road, and W_{f} is a weight of the front wheel on a flat road. Additionally, θ is an inclination angle, H is a height of a vehicle mass center from the ground, L is a horizontal distance between vehicle wheels, and W is a total weight of a vehicle.

The device for controlling parking 100 may further be configured to calculate the limited inclination angle S satisfying the condition of Fb=Fr and Fp=Fr through the following Equations 6 to 9.

$$\begin{matrix}S = \frac{{μ}_{r} {L}_{f}}{L + {μ}_{r} H} & Equation 6 \\ S = \frac{{μ}_{r} {L}_{f}}{L - {μ}_{r} H} & Equation 7 \\ S = \frac{{μ}_{f} {L}_{r}}{L - {μ}_{f} H} & Equation 8 \\ S = \frac{ {μ}_{f} {L}_{r}}{L + {μ}_{f} H} & Equation 9\end{matrix}$$

In particular, Equation 6 calculates the limited inclination angle when the parking system is mounted in the rear wheel and the vehicle is parked on the downhill road, and Equation 7 calculates the limited inclination angle when the parking system is mounted in the rear wheel and the vehicle is parked on the uphill road. Equation 8 calculates the limited inclination angle when the parking system is mounted in the front wheel and the vehicle is parked on the downhill road, and Equation 9 calculates the limited inclination angle when the parking system is mounted in the front wheel and the vehicle is parked on the uphill road.

The device for controlling parking 100 may be configured to determine whether the parking is possible by comparing the parking braking force Fb, the minimum parking braking force Fr, and the limited parking braking force Fp at step S112. The device for controlling parking 100 may further be configured to determine that the parking is possible when the parking braking force Fb is greater than the minimum parking braking force Fr and the limited parking braking force Fp is greater than the minimum parking braking force Fr.

In addition, the device for controlling parking 100 may be configured to determine that the parking is impossible due to a wheel rolling when the parking braking force Fb is less than the minimum parking braking force Fr. Further, the device for controlling parking 100 may be configured to determine that the parking is impossible due to sliding of the vehicle when the limited parking braking force Fp is less than the minimum parking braking force Fr. The parking braking force may be maintained by the parking motor when the parking is possible, and normal parking (e.g., parking is possible) may be displayed (e.g., output to a driver) at step S114. The device for controlling parking 100 may then be configured to release the parking braking force of the parking motor when the parking is impossible, and the warning system 20 may be operated to output a warning to a driver at step S116.

As described, the device for controlling parking according to an exemplary embodiment of the present invention may be configured to determine whether the parking is possible using the parking braking force by a parking motor, the minimum parking braking force, the limited parking braking force, and the limited inclination angle. Therefore, it may be possible to output a warning to the driver regarding whether the parking is possible on the inclined road, to more stably park the vehicle on the inclined road.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A method for controlling parking, comprising:
measuring, by a controller, a road surface friction coefficient or an inclination angle of a road surface;
detecting, by the controller, a parking braking force by a parking motor of a parking system;
calculating, by the controller, a minimum parking braking force necessary for the parking using at least one of the road surface friction coefficient, the inclination angle, and a vehicle weight; and
comparing, by the controller, the parking braking force and the minimum parking braking force, and determining whether the parking is possible.

2. The method of claim 1, wherein the determination of whether the parking is possible includes determining, by the controller, that the parking is impossible when the parking braking force is less than the minimum parking braking force.

3. The method of claim 2, further comprising:
calculating, by the controller, a limited parking braking force using at least one of a position of the parking system, a slope condition of an uphill or downhill road, and the inclination angle.

4. The method of claim 3, wherein the determination of whether the parking is possible includes:
comparing, by the controller, the minimum parking braking force and the limited parking braking force; and
determining, by the controller, that the parking is impossible when the limited parking braking force is less than the minimum parking braking force.

5. The method of claim 3, further comprising:
calculating, by the controller, a vehicle limited inclination angle when the parking braking force is greater than the minimum parking braking force and the limited parking braking force is greater than the minimum parking braking force.

6. The method of claim 5, wherein the determination of whether the parking is possible further includes:
determining, by the controller, that the parking is impossible when the measured inclination angle is greater than the vehicle limited inclination angle.

7. The method of claim 6, wherein the determination of whether the parking is possible further includes:
operating, by the controller, a parking warning system based on receiving a parking warning signal when the parking is impossible to output a warning to a driver indicating that parking is impossible.

8. A device for controlling parking, comprising:
a memory configured to store program instructions; and
a processor configured to execute the program instructions, the program instructions when executed configured to:
measure a road surface friction coefficient or an inclination angle of a road surface;
calculate a minimum parking braking force necessary for parking using at least one of the road surface friction coefficient, the inclination angle, and a vehicle weight, to calculate a limited parking braking force; and
compare at least one of a parking braking force generated by a parking motor, the minimum parking braking force, and the limited parking braking force, and determine whether the parking is possible.

9. The device of claim 8, wherein the program instructions when executed are further configured to:
calculate the minimum parking braking force necessary for the parking using at least one of the road surface friction coefficient, the inclination angle, and the vehicle weight; and
calculate a limited parking braking force using at least one of a position of the parking system, a slope condition of an uphill or downhill road, and the inclination angle.

10. The device of claim 8, wherein the program instructions when executed are further configured to determine that the parking is impossible when the parking braking force is less than the minimum parking braking force.

11. The device of claim 10, wherein the program instructions when executed are further configured to determine that the parking is impossible when the limited parking braking force is less than the minimum parking braking force.

12. The device of claim 8, wherein the program instructions when executed are further configured to calculate a vehicle limited inclination angle when the parking braking force is greater than the minimum parking braking force and the limited parking braking force is greater than the minimum parking braking force.

13. The device of claim 12, wherein the parking is determined to be impossible when the measured inclination angle is greater than the vehicle limited inclination angle.

14. The device of claim 13, wherein the program instructions when executed are further configured to generate a parking warning signal when the parking is impossible.

15. A non-transitory computer readable medium containing program instructions executed by or controller, the computer readable medium comprising:
program instructions that measure a road surface friction coefficient or an inclination angle of a road surface;
program instructions that calculate a minimum parking braking force necessary for parking using at least one of the road surface friction coefficient, the inclination angle, and a vehicle weight, to calculate a limited parking braking force; and
program instructions that compare at least one of a parking braking force generated by a parking motor, the minimum parking braking force, and the limited parking braking force, and determine whether the parking is possible.

16. The non-transitory computer readable medium of claim 15, further comprising:
program instructions that calculate the minimum parking braking force necessary for the parking using at least one of the road surface friction coefficient, the inclination angle, and the vehicle weight; and
program instructions that calculate a limited parking braking force using at least one of a position of the parking system, a slope condition of an uphill or downhill road, and the inclination angle.

17. The non-transitory computer readable medium of claim 15, further comprising program instructions that determine that the parking is impossible when the parking braking force is less than the minimum parking braking force.

18. The non-transitory computer readable medium of claim 17, further comprising program instructions that determine that the parking is impossible when the limited parking braking force is less than the minimum parking braking force.

19. The non-transitory computer readable medium of claim 15, further comprising program instructions that calculate a vehicle limited inclination angle when the parking braking force is greater than the minimum parking braking force and the limited parking braking force is greater than the minimum parking braking force.

20. The non-transitory computer readable medium of claim 19, wherein the parking is determined to be impossible when the measured inclination angle is greater than the vehicle limited inclination angle.
